(19) United States
(12) Patent Application Publication
(10) Pub. No.: US 2004/0245077 A1
(43) Pub. Date: Dec. 9, 2004

(54) Circuit breaker lock-out assembly

(76) Inventor: Steven J Benda, Cokato, MN (US)

Correspondence Address: QUARLES & BRADY LLP, 411 E. WISCONSIN AVENUE, SUITE 2040, MILWAUKEE, WI, 53202-4497, US

(21) Appl. No.: 10/493,169

(22) PCT Filed: Oct. 21, 2002
(86) PCT No.: PCT/US02/33436

(30) Foreign Application Priority Data
Nov. 2, 2001 (US) 60335227

(51) Int. Cl. H01H 9/28

(52) U.S. Cl. 200/43.15

(57) ABSTRACT

The present invention provides a switch lock-out assembly (10) for locking out a switch (15) having a pivotally mounted switch tongue (14) moveable between a first position and a second position about a pivot axis. The switch lock-out assembly (10) includes a body (24) having a first end and a second end. A first clamping surface (70) is formed on the body proximal the first end. A clamp jaw (26) has a second clamping surface (54) which is movable relative to the first clamping surface (70) for clamping a switch tongue (14) between the first clamping surface (70) and second clamping surface (54). An engagement surface (52) is formed on the body a distance from the first end, wherein the engagement surface (52) engages the switch (15) when the switch tongue (14) is clamped between the clamping surfaces (70, 54) to prevent movement of the switch from the switch first position to the switch second position.

### RELATED APPLICATIONS

This application claims benefit of provisional application Ser. No. 60/335,227 filed in the United States Patent and Trademark Office on Nov. 2, 2001.

### BACKGROUND OF THE INVENTION

The field of invention is switch lever lock-outs for locking switch levers in a desired position, and more particularly to switch lever lock-outs which engage the switch lever.

Switches are used in many applications to control the flow of electrical energy. The switches can be used to redirect electrical energy from one circuit to another, and can be used to stop the flow of electrical energy through a circuit. In both cases the circuits become de-energized, that is without a voltage.

One particular type of switch is a circuit breaker which cuts off the flow of electrical energy when the flow of electrical energy through the switch exceeds a predetermined value. Many of these circuit breakers include a switch tongue movable between an “On” position and an “Off” position. Walls adjacent the switch tongue between the “On” and “Off” positions define a switch tongue cavity. Opposing holes in the wall can receive pins to prevent movement of the switch tongue.

Maintenance personnel often use a circuit breaker to interrupt the flow of electrical energy through a circuit when the circuit, or electrical components connected thereto, require maintenance. The circuit breaker, however, is often remote from the location requiring maintenance. Therefore, it is desirable to lock out the circuit breaker to prevent an individual from inadvertently energizing the circuit while maintenance is being performed. Unfortunately, not all circuit breakers have structure, such as opposing holes, or can accommodate lock rails which facilitate locking out the circuit breaker. Therefore, a need exists for a lock-out assembly which does not require structure other than required for operation of the circuit breaker to lock out the circuit breaker.

### BRIEF SUMMARY OF THE INVENTION

The present invention provides a switch lock-out assembly for locking out a switch having a pivotally mounted switch tongue moveable between a first position and a second position about a pivot axis. The switch lock-out assembly includes a body having a first end and a second end. A first clamping surface is formed on the body proximal the first end. A clamp jaw has a second clamping surface which is movable relative to the first clamping surface for clamping a switch tongue between the first clamping surface and second clamping surface. An engagement surface is formed on the body a distance from the first end, wherein the engagement surface engages the switch when the switch tongue is clamped between the clamping surfaces to prevent movement of the switch from the switch first position to the switch second position.

A general objective of the present invention is to provide a lock-out assembly that prevents movement of a switch tongue from a switch first position to a switch second position. This objective is accomplished by providing a lock-out assembly that clamps onto a switch tongue and has an engagement surface which engages the switch to prevent movement of a switch tongue from a switch first position to a switch second position.

Another objective of the present invention is to provide a lock-out assembly that does not require structure other than a switch tongue extending from a switch body to lock-out the switch. This objective is accomplished by providing a lock-out assembly that clamps onto to the switch tongue and engages the switch body without requiring additional switch structure, such as holes formed adjacent the switch tongue or a lock rail fixed adjacent the switch for engagement by the lock-out assembly.

The foregoing and other objectives and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a front, side perspective view of a circuit breaker lock-out assembly incorporating the present invention engaged with a circuit breaker;

FIG. 2 is a rear, side perspective view of the lock-out assembly of FIG. 1 with a lock mechanism;

FIG. 3 is a sectional view of the lock-out assembly of FIG. 1;

FIG. 4 is a front, side perspective view of the lock-out assembly of FIG. 1 disengaged from the circuit breaker;

FIG. 5 is an exploded, front perspective view of the body and clamp jaw of the lock-out assembly of FIG. 1;

FIG. 6 is rear perspective view of the clamp jaw of FIG. 5;

FIG. 7 is a cross sectional view of an alternative body, and

FIG. 8 is a rear perspective view of an alternative clamp jaw.

### DETAILED DESCRIPTION OF THE PREFERRED EMBODIMENTS

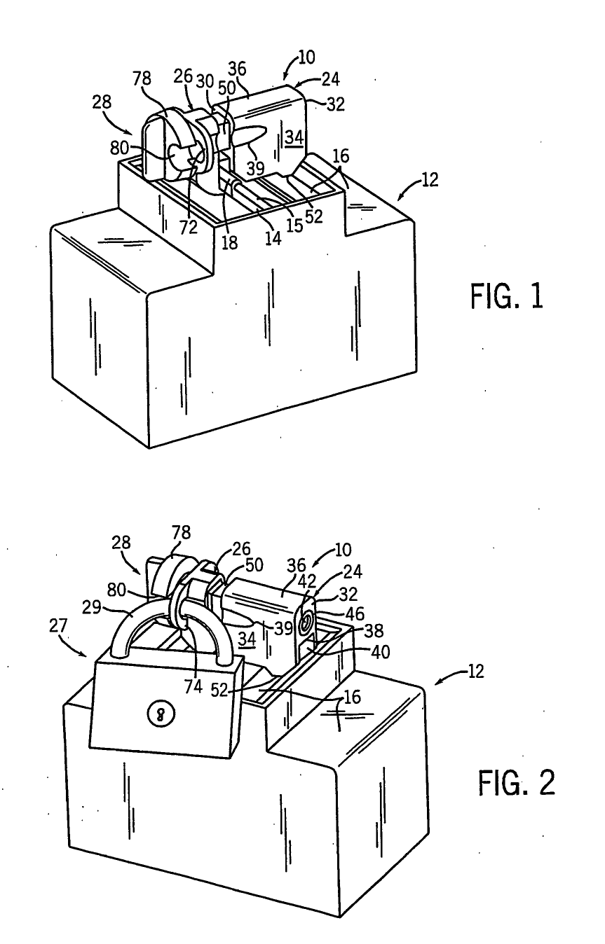

Referring to FIGS. 1-3, a lock-out assembly 10 for use with a circuit breaker engages a multipole circuit breaker 12 to lock-out the circuit breaker 12 and prevent undesired operation. The lock-out assembly 10 clamps onto a switch tongue 14 forming part of the circuit breaker 12, and prevents movement of the switch tongue 14 by engaging the circuit breaker 12 a distance from the switch tongue 14. The circuit breaker 12 can be any commercially available circuit breaker having a switch tongue movable between two or more positions. Moreover, although the present invention is described in relation to a circuit breaker, the present invention can be used with any switch having a switch tongue engageable by the lock-out assembly.

The circuit breaker 12 includes a top wall 16 through which extends a pair of pivotally mounted switch levers 15. The switch levers 15 are joined together by a tie bar 18 to form the switch tongue 14 of the multipole circuit breaker 12, and pivot about an axis between an “On” position and an “Off” position. Preferably, a gap 20 is formed between the switch levers 15 beneath the tie bar 18 for receiving a blade 22, as described herein. Although a multipole circuit breaker 12 for controlling two circuits is shown, the present invention can be used with circuit breakers for controlling one or more circuits without departing from the scope of the invention. Of course, when a single pole circuit breaker is locked out using the lock-out assembly 10, the switch tongue could comprise a single switch lever without a tie bar.

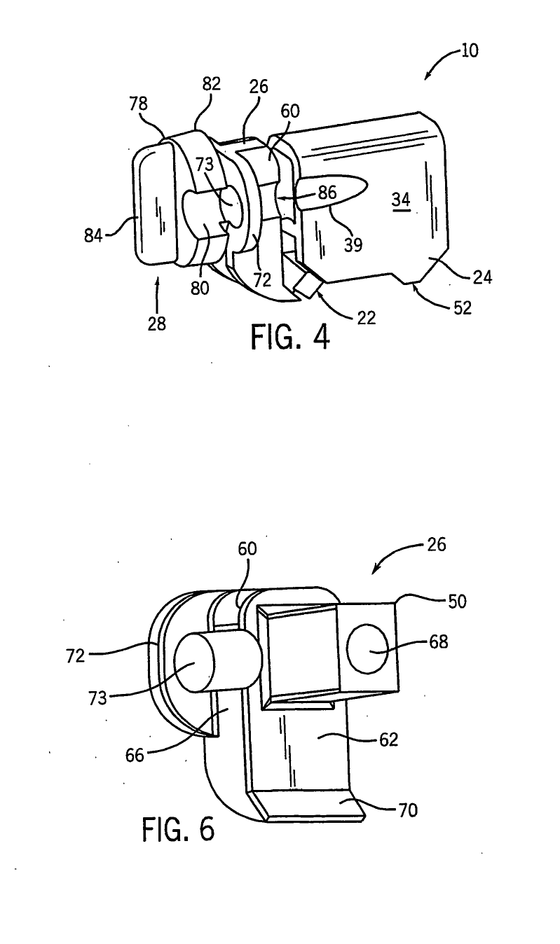

Referring to FIGS. 1-6, the circuit breaker lock-out assembly 10 includes a body 24 which mates with a clamp jaw 26 to clamp onto the switch tongue 14 positioned therebetween. A threaded member 28 extending through the clamp jaw 26 threadably engages the body 24 to urge the clamp jaw 26 toward the body 24 and clamp onto the switch tongue 14. A lock mechanism 27 prevents rotation of the threaded member 28 relative to the body 24 to prevent disengagement of the lock-out assembly 10 from the circuit breaker 12.

The elongated body 24 includes a clamp end 30 and an opposing end 32 joined by sides 34, a top 36, and a bottom 38. The sides 34 and clamp end 30 extend below the bottom 38 to define a rear cavity 40 which is open both rearwardly and downwardly. A scallop 39 is formed in each side 34 of the body 24 to provide unobstructed access to a lock hole 73 formed in the clamp jaw 26.

A longitudinal hole 42 formed through the body 24 between the two ends 30, 32 includes internal threads 44 for threadably engaging the threaded member 28. Preferably, the body 24 is molded from a plastic material, and a threaded insert 46 having the internal threads 44 is received in the hole 42 for threadably engaging the threaded member 28.

The clamp end 30 faces the clamp jaw 26, and includes a forwardly opening front cavity 48 aligned with the longitudinal hole 42. The front cavity 48 receives a projection 50 extending rearwardly from the clamp jaw 26 to slidably fix the clamp jaw 26 to the body 24 for slidable movement parallel to the longitudinal axis 43 of the threaded member 28. Advantageously, slidably fixing the clamp jaw 26 to the body 24 simplifies the installation of the lock-out assembly 10 onto the circuit breaker 12. Although a front cavity 48 for receiving the projection 50 extending from the clamp jaw 26 is shown, other methods can be used for slidably fixing the clamp jaw 26 to the body 24, such as pins extending between the clamp jaw 26 and body 24, without departing from the scope of the invention. Moreover, the invention can be practiced without structure slidably fixing the lockjaw 26 to the body 24 without departing from the scope of the present invention.

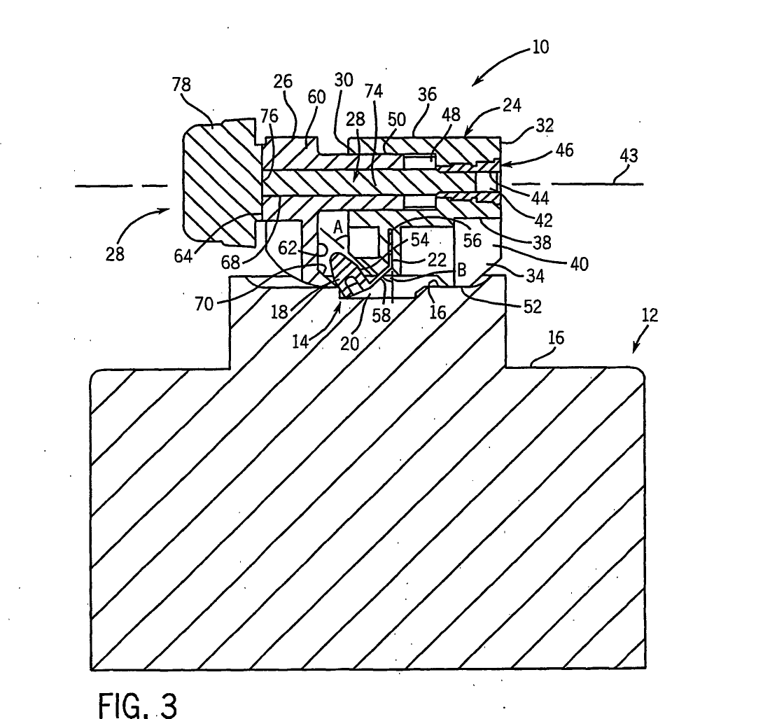

As shown in FIG. 3, when the lock-out assembly 10 is clamped onto the switch tongue 14, engagement surfaces 52 formed on downwardly facing edges of the body sides 34 proximal the opposing end 32 engage the circuit breaker top wall 16. The engagement surfaces 52 prevent movement of the switch tongue 14 from one position, such as the “Off” position, to a second position, such as the “On” position by impinging on the circuit breaker top wall 16 to prevent rotation of the switch tongue 14 clamped between the body 24 and clamp jaw 26.

The engagement surfaces 52 are spaced a distance rearwardly from the clamp end 30 to form a lever arm which resists movement of the switch tongue 14. Preferably, the engagement surfaces 52 are spaced a distance rearwardly from the clamp end 30 and are offset from the pivot axis of the circuit breaker switch tongue 14. Advantageously, by providing an engagement surface on the body which impinges on the circuit breaker, the body can be formed to have a length which is less than the distance between the switch tongue and the edge of the circuit breaker.

Although engagement surfaces 52 formed on the downwardly facing edges of the sides 34 are disclosed, one or more engagement surfaces can be formed on other parts of the body, such as the opposing end, the bottom, and the like depending upon the particular circuit breaker. For example, a rearwardly facing engagement surface for engaging a wall extending upwardly from a circuit breaker top wall can be used without departing from the scope of the present invention.

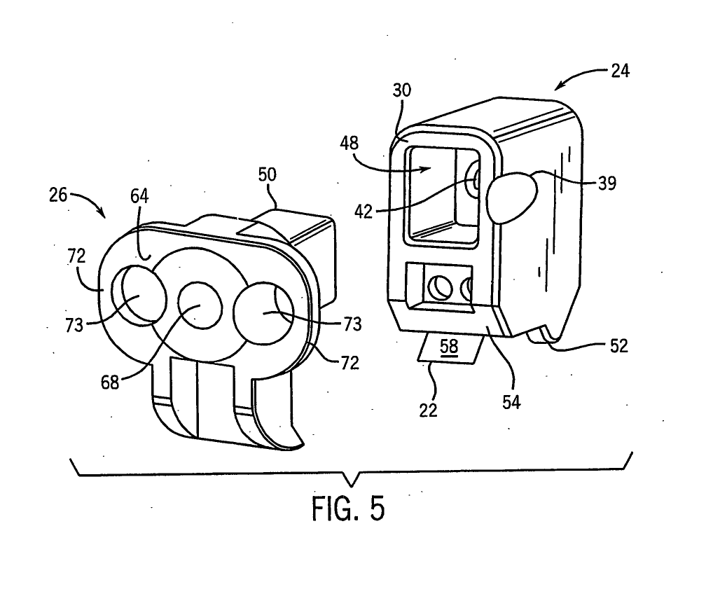

Referring to FIGS. 3 and 5, a clamping surface 54 formed as an integral part of the body clamp end 30 engages an upwardly facing side of the switch tongue 14 and cooperates with the clamp jaw 26 to secure the lock-out assembly 10 to the switch tongue 14. Preferably, the clamping surface 54 defines an angle A relative to the body clamp end 30, wherein the angle A corresponds to the orientation of the surface of the switch tongue 14 engaged by the clamping surface 54. Of course, the clamping surface 54 can include texturing, an adhesive coating, a friction enhancing fabric, and the like, to inhibit movement of the clamping surface 54 parallel to a plane defined by the clamping surface 54 without departing from the scope of the present invention.

Movement of the clamping surface 54 in a direction parallel to a plane defined by the clamping surface 54 can also be inhibited by a blade 22 extending from the lock-out assembly body 24 below the clamping surface 54. The blade 22 slips into the gap 20 below the tie bar 18 to prevent movement of the lock-out assembly body 24 in a direction parallel to the clamping surface 54. Advantageously, if the lock-out assembly 10 is not securely clamped onto the switch tongue 14 (i.e. the lock-out assembly 10 is clamped onto the switch tongue 14, and the switch tongue 14 can still move relative to the clamping surface 54), the blade 22 prevents rotation of the switch tongue 14 along an arc passing through the blade 22.

Preferably, the blade 22 is formed from high tensile steel, such as spring steel, fully hardened steel, and the like, and has one end 56 embedded in the body 24 and an exposed end 58 which slips into the gap 20 formed in the switch tongue 14. Most preferably, the exposed end 58 defines an angle B, such as 45° relative to a vertical line. Although a spring steel blade is preferred, a blade formed from any material capable of resisting movement can be used without departing from the scope of the present invention. Moreover, providing a means for preventing movement of the body in a direction parallel to the clamping surface is preferred, the present invention can be practiced without such means without departing from the scope of the present invention.

Referring to FIGS. 3-6, the clamp jaw 26 is movable relative to the body clamp end 30 to clamp the switch tongue 14 therebetween. The clamp jaw 26 includes a base 60 having a rear face 62 facing the body clamp end 30 and a front face 64. The front and rear faces 64, 62 are joined by sides 66. The projection 50 extends rearwardly from the rear face 62, and is received in the body front cavity 48. A throughhole 68 for receiving the threaded member 28 is formed in the base 60 and extends through the projection 50. The throughhole 68 is coaxial with the body longitudinal hole 42. A rearwardly facing clamping surface 70 formed on the clamp jaw 26 extends below the rear face 62, and engages a downwardly facing side of the switch tongue 14.

The clamp jaw clamping surface 70 cooperates with the body clamping surface 54 to clamp the switch tongue 14 therebetween. Preferably, the clamp jaw clamping surface 70 defines an angle relative to vertical which is substantially equal to the angle of the body clamping surface 54. Of course, if the switch tongue sides are vertical, the clamping surfaces 54, 70 are preferably vertical, as well. As in the body clamping surface 54, the clamp jaw clamping surface 70 can include texturing, an adhesive coating, a friction enhancing fabric, and the like to inhibit movement of the clamping surface parallel to a plane defined by the clamping surface without departing from the scope of the present invention.

Ears 72 extending outwardly from each base side 66 include a lock hole 73 for receiving the lock mechanism member 29 (shown in FIG. 2) to prevent rotation of the threaded member 28 and to lock the clamp jaw 26 relative to the body 24. Although two ears 72 are shown with each ear 72 having a single lock hole 73, one or more ears can be provided with one or more lock holes without departing from the scope of the present invention.

The threaded member 28 has an externally threaded elongated shaft 74 which extends through the clamp jaw throughhole 68 into the longitudinal hole 42 to threadably engage the internal threads 44. One end 76 of the threaded member shaft 74 has a head 78 which slidably engages the front face 64 of the clamp jaw 26. Advantageously, the head 78 urges the clamp jaw 26 toward the body 24 by rotating the threaded member 28 in a direction which increases the threaded engagement of the internal threads 44.

The head 78 is disc shaped, and coaxially fixed to the one end 76 of the threaded member shaft 74. Cutouts 80 are formed in the circumferential edge 82 of the head 78 for receiving the lock mechanism member 29 when aligned with one of the lock holes 73 formed in one of the clamp jaw ears 72. Advantageously, when the lock mechanism member 29 is received through one of the lock holes 73 and one of the cutouts 80, rotation of the threaded member 28 is prevented thus locking the clamp jaw 26 relative to the body 24. A center rib 84 extends axially from the head 78 for engagement by a user rotating the head 78, and, thus, the threaded member 28.

Referring to FIGS. 2-6, the lock mechanism 27, such as a padlock, includes a member 29, such as a hasp, which extends through a passageway 86 defined by the aligned lock hole 73 and threaded member cutout 80. The lock mechanism member 29 extending through the passageway 86 prevents rotation of the threaded member 28 relative to the body 24, and thus prevents the clamping surfaces 54, 70 from releasing the switch tongue 14. Preferably, the lock mechanism 27 can be locked, such as by a key or tumbler combination, to prevent an unauthorized user from removing the lock mechanism member 29 from the passageway 86.

In use, the clamp jaw and body clamping surfaces 54, 70 are positioned on opposing sides of a switch tongue 14 with the body 24 extending in the undesired direction of movement of the switch tongue 14. The threaded member 28 is rotated to urge the clamp jaw 26 toward the body 24 and clamp the switch tongue 14 between the clamping surfaces 54, 70. Movement of the switch tongue 14 in the undesired direction causes the engagement surfaces 52 of the body 24 to impinge on the circuit breaker top wall 16, thus preventing complete movement of the switch tongue 14 from the first position, such as the “Off” position to the second position, such as the “On” position.

Disengagement of the lock-out assembly 10 from the circuit breaker 12 is prevented by aligning one of the cutouts 80 formed in the threaded member head 78 with one of the lock holes 73 formed in one of the clamp jaw ears 72. The lock mechanism member 27, such as a padlock hasp, is received in the passageway 86 defined by the aligned cutout 80 and lock hole 73, and the lock mechanism 27 is then locked to prevent unauthorized removal of the lock mechanism member 27 and rotation of the threaded member 28.

The lock-out assembly 10 is removed from the circuit breaker 12 to allow movement of the switch tongue 14 to another position by first, unlocking the lock mechanism 27. The lock mechanism member 29 is then withdrawn from the passageway 86 to allow rotation of the threaded member 28. The threaded member 28 is then rotated to allow the clamp jaw 26 to move away from the body 24 and release the switch tongue 14 clamped between the clamping surfaces 54, 70. The lock-out assembly 10 is then pulled away from the circuit breaker 12 to allow movement of the switch tongue 14 to another position.

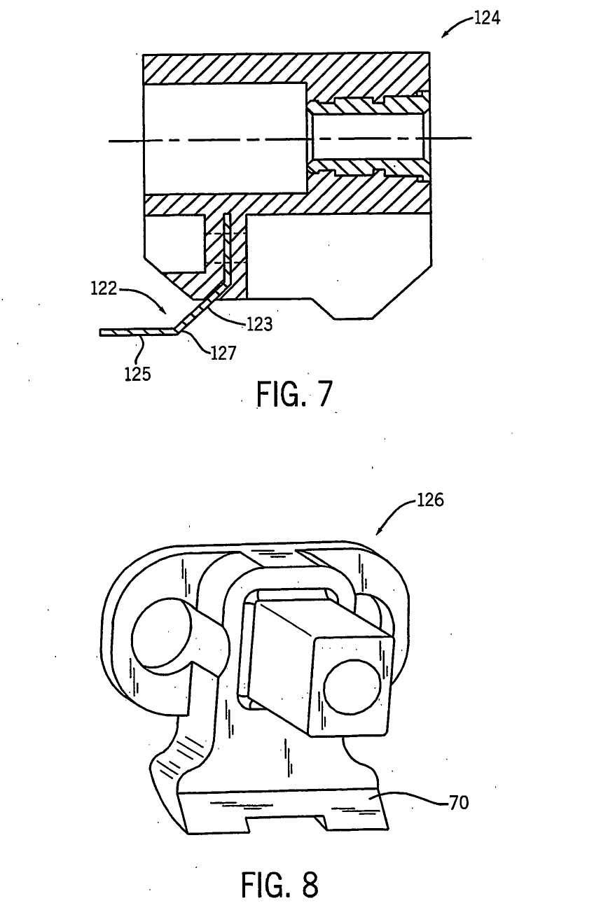

In a second embodiment of the present invention shown in FIG. 7, the blade 122 has a first portion 123 and a second portion 125. The first portion 123 extends from the body 124 at an angle relative to a vertical line, as in the first embodiment, and has a distal end 127. The second portion 125 of the blade 122 extends from the distal end 127 of the first portion 123 at an angle relative to the vertical, wherein the angle of the second portion 125 is different than the angle of the first portion 123. Preferably, the first portion 123 extends at an angle of 45° relative to the vertical line, and the second portion 125 of the blade extends at an angle of 90° relative to the vertical line.

In yet another embodiment of the present invention shown in FIG. 8, a clamp jaw 126 has a widened clamping surface 170 than in the first embodiment. The wider clamping surface 170 is preferred to increase the area of the switch tongue 14 engaged by the clamp jaw 126.

While there have been shown and described what is at present considered the preferred embodiments of the invention, it will be obvious to those skilled in the art that various changes and modifications can be made therein without departing from the scope of the invention defined by the appended claims. For example, the overall shape of the body and clamp jaw can be modified to conform to switches having various geometries.

I claim:

1. A switch lock-out assembly for locking out a switch having a pivotally mounted tongue moveable between a first position and a second position about a pivot axis, said switch lock-out assembly comprising:
a body having a first end and a second end;
a first clamping surface formed on said body proximal said first end;
a clamp jaw having a second clamping surface, said second clamping surface being movable relative to said first clamping surface for clamping a switch tongue between said first clamping surface and said second clamping surface; and
an engagement surface formed on said body a distance from said first end, wherein said engagement surface engages the switch to prevent movement of the switch from the switch first position to the switch second position.

2. The lock-out assembly of claim 1, including a blade extending from said body, said blade being engageable with the switch tongue to inhibit disengagement of said clamping surfaces from said tongue.

3. The lock-out assembly of claim 2, in which said blade is formed from a high tensile steel.

4. The lock-out assembly of claim 1, in which a threaded member having an axis extends through an aperture formed in said clamp jaw and threadably engages one of said body and said clamp jaw, wherein rotation of said threaded member about said axis in a first direction urges said clamp jaw in an axial direction toward said body to clamp the circuit breaker tongue between said clamping surfaces.

5. The lock-out assembly of claim 4, in which a longitudinal hole having internal threads is formed in said body for threadably engaging said threaded member.

6. The lock-out assembly of claim 5, in which said internal threads are provided on an insert in said longitudinal hole.

7. The lock-out assembly of claim 4, in which said threaded member includes a head engaging said clamp jaw.

8. The lock-out assembly of claim 4, in which said threaded member includes a head having structure for receiving a lock mechanism member which prevents rotation of said threaded member.

9. The lock-out assembly of claim 1, in which said clamp jaw includes an opening for receiving a lock mechanism member which prevents rotation of said threaded member.

10. The lock-out assembly of claim 1, in which one of said body and said clamp jaw includes a cavity opening towards the other of said body and said clamp jaw, and said other of said body and said clamp jaw includes a projection received in said cavity to slidably fix said clamp jaw to said body.

11. The lock-out assembly of claim 1, in which said engagement surface is formed proximal said second end.

12. The lock-out assembly of claim 1, in which said clamping surfaces are parallel to each other.

13. The lock-out assembly of claim 1, including a lock mechanism which prevents movement of said clamping surfaces relative to each other to prevent unclamping said clamping surfaces from a switch tongue.

14. A switch lock-out assembly for locking out a switch having a pivotally mounted tongue moveable between a first position and a second position about a pivot axis, said switch lock-out assembly comprising:
a body having a first end and a second end;
a longitudinal hole formed in said body between said first and second ends;
a first clamping surface formed on said body proximal said first end;
a clamp jaw having a throughhole and a second clamping surface, said second clamping surface being movable relative to said first clamping surface for clamping a switch tongue between said first clamping surface and said second clamping surface;
an engagement surface formed on said body a distance from said first end, wherein said engagement surface engages the switch to prevent movement of the switch from the switch first position to the switch second position;
a blade extending from said body, said blade being engageable with the switch tongue to inhibit disengagement of said clamping surfaces from said tongue;
internal threads formed in at least one of said longitudinal hole and said throughhole; and
a threaded member extending at least partially through said longitudinal hole and said throughhole along an axis and having external threads threadably engaging said internal threads, wherein rotation of said threaded member about said axis in a first direction urges said clamp jaw in an axial direction toward said body to clamp the circuit breaker tongue between said clamping surfaces.

15. The lock-out assembly of claim 14, in which said blade is formed from a high tensile steel.

16. The lock-out assembly of claim 14, in which said threaded member includes a head engaging said clamp jaw.

17. The lock-out assembly of claim 14, in which said threaded member includes a head having structure for receiving a lock mechanism member which prevents rotation of said threaded member.

18 The lock-out assembly of claim 14, in which one of said body and said clamp jaw includes a cavity opening towards the other of said body and said clamp jaw, and said other of said body and said clamp jaw includes a projection received in said cavity to slidably fix said clamp jaw to said body.

19. The lock-out assembly of claim 14, in which said engagement surface is formed proximal said second end.

20. The lock-out assembly of claim 14, in which said clamping surfaces are parallel to each other.

21. The lock-out assembly of claim 14, including a lock mechanism which prevents movement of said clamping surfaces relative to each other to prevent unclamping said clamping surfaces from a switch tongue.
